(19) United States
(12) Patent Application Publication
(10) Pub. No.: US 2010/0227545 A1
(43) Pub. Date: Sep. 9, 2010

(54) Air vent outlet cover and filter

(76) Inventor: Nicholas John Frois, Reno, NV (US)

Correspondence Address: Nicholas John Frois, 2970 Fairwood Dr., Reno, NV, 89502, US

(21) Appl. No.: 12/717,948

(22) Filed: Mar. 4, 2010

Related U.S. Application Data
(60) Provisional application No. 61/158,382, filed on Mar. 8, 2009.

(51) Int. Cl. F24F 13/20; B01D 50/00

(52) U.S. Cl. 454/358; 55/495; 96/222

(57) ABSTRACT

This invention relates generally to an air vent outlet filter and cover and more particularly to an air vent filter and cover that adheres to the air vent outlet and that performs multiple functions including, but not limited to, a coarse particle air filter, to infuse a fragrance to the air being filtered and as a decoration. The air vent cover is attached to the air vent outlet by means of a flexible permanent magnet strip on the backside perimeter of the filter cover or by means of a sticky surface on the backside perimeter of the filter cover.

This invention relates generally to an air vent outlet filter and cover. This invention is related to Provisional Application No. 61/158,382 entitled “Air vent outlet cover and filter” filed on Mar. 8, 2009

### BACKGROUND OF THE INVENTION

Central air heating and cooling systems use ducting to transport air to various rooms from a centrally located heating and cooling system. The heated or cooled air exits the ducts into a room through air vents. Air vents perform two main functions; one to direct the air into the room and the other is to open and limit the airflow to the room.

Central air heating and cooling systems are equipped with filters located at the main heating and cooling system. This filter removes most of the particles in the air. Some particles can still be present in the air and will exit into the room through the air vents.

It would be both advantageous and beneficial to further filter the air before it enters the room.

### BRIEF DESCRIPTION OF THE INVENTION

Briefly, in accordance with one embodiment, an air vent outlet cover comprises:
A frame the fits over the flat portion of an air vent;
A flexible magnet that is part of the backside of the air vent cover frame to attach the air vent filter cover to the air vent;
A filter that is affixed to the frame that ensures that only air can flow though the filter.

According to another embodiment, an air vent outlet cover comprises:
A frame the fits over the flat portion of an air vent;
A flexible sticky strip is part of the backside of the air vent cover frame to attach the air vent filter cover to the air vent;
A filter that is affixed to the frame that ensures that only air can flow though the filter.

According to yet another embodiment of the invention, the filter of the air vent cover can be impregnated with a substance that gives off a fragrance when air flows through the filter.

According to still another embodiment of the invention, the external side of the filter of the air vent cover can be decorated by means, but not limited to, of printing.

According to yet still another embodiment of the invention, the shape and size of the air vent cover can be made to accommodate various shapes, profiles and sizes of various air vent outlets.

### DRAWINGS

These and other features, aspects, and advantages of the present invention will become better understood when the following detailed description is read with reference to the accompanying drawings in which like characters represent like parts throughout the drawings, wherein:

FIG. 1 illustrates an air vent outlet that is known in the art;

FIG. 2 illustrates the air vent cover according to one embodiment of the invention;

FIG. 3 illustrates the air vent cover filter according to one embodiment of the invention;

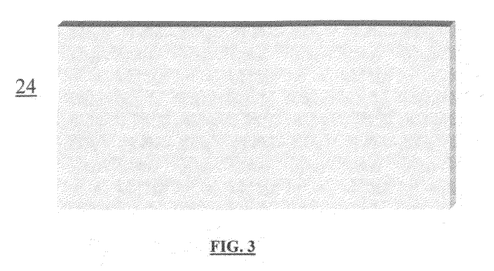

FIG. 4 illustrates the air vent cover frame according to one embodiment of the invention.

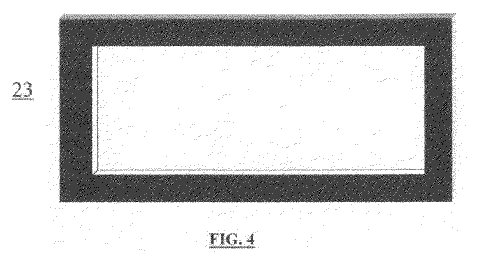

FIG. 5 illustrates the air vent cover frame according to one embodiment of the invention.

While the above-identified drawing figures set forth one embodiment of the invention, other embodiments of the present invention are also contemplated, as noted in the discussion. In all cases, this disclosure presents an illustrated embodiment of the present invention by way of representation and not limitation. Numerous other modifications and embodiments can be devised by those skilled in the art which fall within the scope and spirit of the principles of this invention.

### DETAILED DESCRIPTION OF THE INVENTION

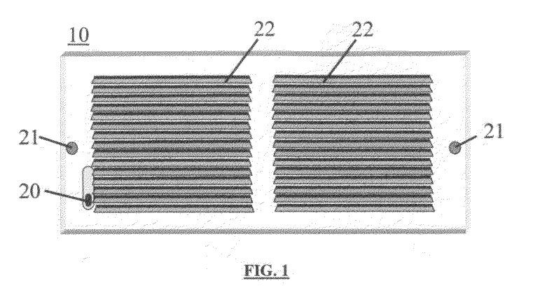

FIG. 1 illustrates an air vent 10 that is known in the art. Some air vents come with a lever 20 to control the flow of air the exits from the air vent. The air vent further has mounting holes 21 to attach to the wall or ceiling and air duct. The heated or cooled air from the air duct exits the air vent through slots 22 that direct the air-flow in a present direction.

Traditionally central air heating and cooling systems provide filtering of the air within the main central unit before the air passes into the air ducts.

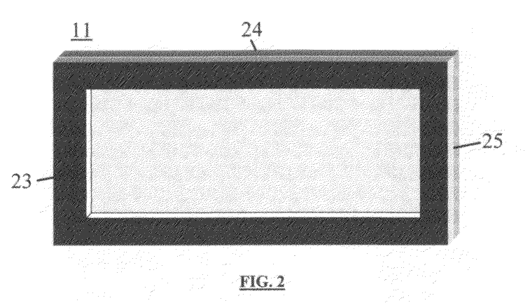

FIG. 2 illustrates an air vent cover 11 according to one embodiment of the invention. The air vent cover 11 comprises a frame 23 and a filter 24 that is attached to the frame by means of adhesive 25.

In one embodiment of the invention, the preferred means of semi-permanent attachment of the air vent cover to the air vent is using a flexible magnetic strip that is also the frame 23 of the air vent cover 11.

In another embodiment of the invention, the means of semi-permanent attachment of the air vent cover to the air vent is using a flexible Sticky strip that is mounted to the backside of the frame 23 of the air vent cover 11.

In yet another embodiment of the invention, the filter 24 can be impregnated with a fragrance that is released into the air flowing through the filter.

In still yet another embodiment of the invention, the filter 24 can be decorated. The decorations can be simple images or even a form of advertising. The decorations can be printed, but not limited to, onto the external surface of the filter 24.

Looking at FIG. 1. A typical air vent is equipped with a lever 20 to adjust the flow rate of air that enters a room. This level can also completely block the air from flowing into the room. In yet another embodiment of the invention, an access opening for the air vent lever is provided in the filter 24.

In still yet another embodiment of the invention, once the filter 24 becomes clogged with particles or the fragrance in the filter has become depleted, the air vent cover can be disposed of.

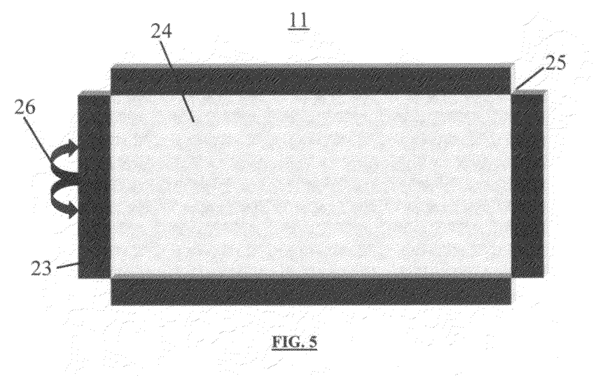

Looking at FIG. 5. The air vent cover can be made in various shapes and sizes to accommodate the many sizes, shapes and profiles of air vents. Sections of the air vent cover and be made to fold in various directions 26 to adjust to the profile of the air vent outlet.

While only certain features of the invention have been illustrated and described herein, many modifications and changes will occur to those skilled in the art. It is, therefore, to be understood that the appended claims are intended to cover all such modifications and changes as fall within the true spirit of the invention.

1. An air vent outlet cover comprising:
a means of attaching to the air vent outlet; and
an air filter configured to filter the air exiting the air vent.

2. The air vent outlet cover according to claim 1, wherein the means of attachment comprises a flexible magnetic strip mounted around the perimeter of the backside of the cover.

3. The air vent outlet cover according to claim 1, wherein the means of attachment comprises a flexible sticky strip mounted around the perimeter of the backside of the cover.

4. The air vent outlet cover according to claim 1, wherein the filter is infused with a fragrance that will be transferred to the air exiting the air vent outlet.

5. The air vent outlet cover according to claim 1, wherein the external surface of the air vent cover can be decorated.

6. The air vent outlet cover according to claim 1, wherein an opening is provided in the filter cover to allow the control mechanism of the air vent to be accessed.

7. The air vent outlet cover according to claim 1, wherein the air filter cover is disposable after the filter is filled with particles and or the fragrance has worn off.

8. The air vent outlet cover according to claim 1, wherein the air filter cover can be shaped to accommodate non flat surface air vents.

9. The air vent outlet cover according to claim 1, wherein the air filter cover can be a series of various shapes and sizes that can accommodate a variety of air vent outlet shapes, sizes and profiles.
